(19) United States
(12) Patent Application Publication
(10) Pub. No.: US 2018/0241635 A1
(43) Pub. Date: Aug. 23, 2018

(54) METHOD FOR ENABLING AUTOMATION OF MANAGEMENT AND ORCHESTRATION OF NETWORK SLICES

(71) Applicants: Jaya Rao, Ottawa (CA); Sophie Vrzic, Kanata (CA)

(72) Inventors: Jaya Rao, Ottawa (CA); Sophie Vrzic, Kanata (CA)

(73) Assignee: Huawei Technologies Co., Ltd., Shenzhen (CN)

(21) Appl. No.: 15/438,201

(22) Filed: Feb. 21, 2017

(51) Int. Cl. H04L 12/24

(52) U.S. Cl. CPC H04L 41/14; H04L 67/10; H04L 41/0803

(57) ABSTRACT

A method for managing a network function (NF) entity in a network slice instance. The method comprises actions of accessing descriptor entities (DE) that each DE describes deployment and operational behaviour of the NF entity, including at least one DE that relates to the network slice instance and issuing a request to update a configuration of the NF entity. The DE lies in the management plane. The update request is in accordance with policy in the accessed DEs. The method may also comprise the action of obtaining performance feedback information from the NF entity regarding performance of the NF entity.

### RELATED APPLICATIONS

Not Applicable.

### TECHNICAL FIELD

The present disclosure relates to network functions (NFs) and in particular to a method to support mechanisms for automation of the management and orchestration of network slice instances.

### BACKGROUND

The demand for network resources in terms of bandwidth, computing power and storage capacity is ever-increasing. One approach under consideration to meet this increasing demand is through virtualization of networks and network slicing, in which pooled network resources are used to create a series of network slices. Within each slice, one or more existing network nodes are instantiated with those NFs that provide a dynamic service level capability for a particular service. The use of network slices permits only those NFs that are appropriate to be instantiated, and only as and when appropriate. In some examples, the NF can be located in the control plane. In some examples, the NF can be located in the user plane.

The network functionality of a particular slice may be implemented by downloading and instantiating, as a virtual network function (VNF), certain network functionality from cloud-based resources to one or more existing nodes or points of presence (PoP). A given PoP may have downloaded and instantiated thereon one or more than one VNF, each corresponding to one or more than one slice. When the functionality is no longer appropriate, the corresponding VNF may be terminated or deactivated or modified to reflect more appropriate functionality.

In some cases, one or more VNFs may work in conjunction with one or more non-virtualized physical network functions (PNFs) (collectively network elements and/or NFs) that perform dedicated (and substantially unchangeable) functions within a network. For example, the network may have legacy components, including without limitation, a mobility management entity (MME), that perform fixed NFs that can continue to be appropriated for use in connection with a network slice instance.

Management and orchestration (MANO) is a framework that describes the management of VNFs in a network function virtualization (NFV) architecture. In NFV, an application or service will call on certain VNFs to help execute. MANO encompasses the configuration of the lifecycle management (LCM) and configuration management (CM) of such NFs.

In this context LCM mainly applies to VNFs and includes automated VNF creation, modification, resource scaling (both up/down and in/out) and termination actions such as taking them online and/or offline, scaling them, making them redundant and/or configuring them.

In this context CM enforces policies and procedures that initialize, update, evaluate and track the behaviour of NFs, which may be VNFs and/or PNFs.

In some examples, a MANO module 100, such as is shown in FIG. 1, may comprise one or more of an Orchestrator 110, a virtual network function manager (VNFM) 120 and/or a virtual infrastructure manager (VIM) 130 component. The Orchestrator 110 is responsible for performing LCM of network slice instance(s) in conjunction with the VNFM 120 and the VIM 130. The Orchestrator 110 identifies suitable PoP(s) on which to host the VNF(s) belonging to a network slice instance and passes these locations onto the VNFM 120. The VNFM 120 performs LCM of the VNFs. In some examples, the Orchestrator 110 provides instructions to trigger LCM actions on the VNF(s). The VIM 130 manages the pooled resources of the VNF. In some examples, the Orchestrator 110 provides VNF resource demands to the VIM 130 and the VIM 130 provisions the demanded resources and returns the resource locations to the Orchestrator 110.

In this context, automation refers to the ability to programmatically manage the NFs and provision resources in a timely manner through the lifecycle of a network slice instance. Automation serves to help realize stable and predictable network operational conditions with minimal service provisioning and management complexity. For example, an NF that is common to multiple slice instances may be modified for the purposes of one of such slice instances or may be provisioned to support a new slice instance, without impacting the ability of the NF to serve the other slice instances.

Further, automation helps to achieve well-structured and policy-driven network slice operations while avoiding manual and/or time-consuming configuration procedures. In some cases, automation allows various NFs that are impacted by a configuration change to be modified substantially simultaneously so as to avoid cascading configuration times or periods during which such NFs are incompatibly conFIG.d.

Automation also permits the identification of certain criteria, which, if met, trigger auto-configuration of NFs. This may permit detection and diagnosis of network problems and provide auto-healing, auto-scaling and/or other auto-configuration functionalities that allow the network to respond pro-actively to changes in network conditions, such as demand.

The current network management framework has limited programmability and tends to rely on manual configuration procedures. While there are configuration management tools that purport to provide some subset of automation capability, such as the Puppet and the Chef environments, these tools generally support installation and configuration only on a per-node or a per-NF basis.

Further, such components are monolithic, supporting single-tenant and/or single-platform environments. Still further, they typically do not support carrier-grade scaling and reliability demands. Moreover, these tools are specific, in terms of networking, computation and/or storage definitions, to particular clouds and their individual demands.

Finally, existing automation frameworks do not support the concept of network slices, much less the dependencies between common NFs and slice-specific functions.

### BRIEF DESCRIPTION OF THE DRAWINGS

Example embodiments of the present disclosure will now be described by reference to the following FIG.s, in which identical reference numerals in different FIG.s indicate identical elements and in which:

FIG. 1 is an example block diagram of a MANO module;

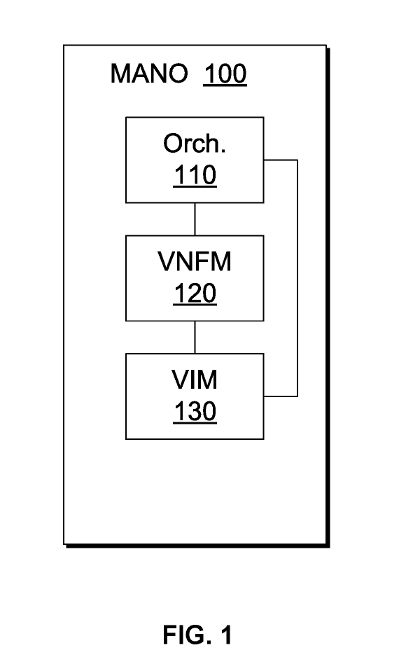

FIG. 2 is a block diagram showing examples of management functions (MFs) that may be used to conFIG. a VNF;

FIG. 3 is a block diagram showing examples of additional components to those shown in FIG. 2 according to an example;

FIG. 4 is a block diagram showing examples of a configuration manager of FIG. 3 considering VNFDs from multiple slice instances to generate a configuration script;

FIG. 5 is a block diagram showing examples of MFs that may be used to conFIG. a non-virtualized PNF according to an example;

FIG. 6 is a block diagram showing an example processing flow for performing closed loop automation (CLA) according to an example;

FIG. 7 is a block diagram showing an example processing flow for performing open loop automation (OLA) according to an example;

FIG. 8 is an example message flow diagram for the components of FIG. 3 in the context of auto-scaling in CLA;

FIG. 9 is an example message flow diagram FIG. 3 in the context of auto-scaling in OLA;

FIG. 10 is an example message flow diagram FIG. 3 in the context of auto-configuration in CLA;

FIG. 11 is an example message flow diagram FIG. 3 in the context of auto-configuration in OLA;

FIG. 12 is an example message flow diagram FIG. 3 in the context of on-demand scaling in CLA;

FIG. 13 is an example message flow diagram FIG. 3 in the context of on-demand scaling in OLA;

FIG. 14 is an example message flow diagram FIG. 3 in the context of on-demand configuration in CLA;

FIG. 15 is an example message flow diagram FIG. 3 in the context of on-demand configuration in OLA;

FIG. 16 is a flow chart showing method actions according to an example; and

FIG. 17 is a schematic view of a processing system according to an example.

For purposes of explanation and not limitation, specific details are set forth in order to provide a thorough understanding. In some instances, detailed descriptions of well-known devices, circuits and methods are omitted so as not to obscure the description with unnecessary detail.

### SUMMARY

Methods for automating configuration of functionality of an NF are desirable.

End-to-end automation in network slice instances is provided by enabling MFs to leverage policy, templates and descriptors at the application level, along with configuring VNFs and PNFs at the infrastructure level.

Such an automation framework facilitates a well-structured and policy-driven network slice operation that can be elastically adapted based on dynamic service constraints while avoiding time-consuming, manual procedures.

The automation framework takes into account dependencies between network slice instances composed of slice-specific (and common) NFs. Thus, any management-related modifications to NFs of a given slice instance will not negatively impact operation of other slice instances supported by such NFs.

The MFs employ multi-dimensional descriptor entities (DEs) to enable automation to identify inter-dependencies between NFs, both within a slice instance to and across different slice instances.

The MFs in the automation framework support:
policy-driven analytics to make automated asynchronous and secure LCM and/or CM decisions. Such decisions can be made both at the initialization phase and/or during run-time, such that each NF within slice instances can be independently and/or automatically modified through the lifetime of the slice instance without jeopardizing complex dependencies among common NFs within and across multiple slice instances;
heterogeneous infrastructure platforms comprising VNFs and non-virtualized PNFs;
decoupling of and awareness of both application and infrastructure functionality;
different automation policies in different segments of network slice instances, including managing common NFs differently from slice-specific NFs;
robustness and scalability with a hierarchical architecture that avoids single points of failure;
fast failure recovery and healing mechanisms facilitating automatic convergence of affected NFs to a stable desired state;
event trigger-driven reactive and schedule-driven proactive automation mechanisms; and
open-loop and closed-loop automation modes.

A method for enabling configuration of functionality of a NF in a network slice instance is disclosed. The method comprises accessing all descriptor entities (DE) that describe deployment and operational behaviour of an NF including at least one DE that relates to the network slice instance and issuing a request to update a configuration of an NF in accordance with a policy in each accessed DE. In some examples, the method supports OLA. In some examples, the method comprises obtaining performance feedback information from the NF regarding the performance of the NF to support CLA.

An apparatus for performing the method comprises a management plane entity and at least one of at least one application VNF descriptor (VNFD-A) and at least one infrastructure VNF descriptor (VNFD-I) accessible thereby. Each VNFD-A and/or VNFD-I corresponds to at least one VNF for each network slice instance associated with the VNF. In some examples a VNFD-A and a VNFD-I correspond to the same VNF.

The management plane entity accesses data from the at least one VNFD-A to conFIG. an application function (NF-A) of the at least one VNF corresponding thereto.

In some examples, the VNFD-A is accessible by an element manager (EM). In some examples, the EM comprises at least one of an application performance manager (A-PM) and an application configuration manager (A-CM). In some examples, the A-CM generates an application configuration script for execution by the at least one NF-A of the VNF corresponding thereto.

In some examples, the at least one NF-A provides inputs to the A-PM to support application-level CLA of the NF configuration of the VNF corresponding thereto.

The management plane entity accesses data from the at least one VNFD-I to conFIG. an infrastructure function (NF-I) of the at least one VNF corresponding thereto.

In some examples, the VNFD-I is accessible by the VNFM. In some examples, the VNFM comprises at least one of an infrastructure performance manager for VNFs (VNF PM) and an infrastructure configuration manager for VNFs (VNF CM). In some examples, the VNF CM generates an infrastructure configuration script for execution by the at least one NF-I of the VNF corresponding thereto.

In some examples, the VNFM is a component of a NFV MANO module. In some examples, the NFV MANO module comprises a VIM and a NFV Orchestrator (NFVO).

In some examples, the at least one NF-I provides inputs to the VNF PM to support infrastructure-level CLA of the NF configuration of the VNF corresponding thereto.

In some examples, the apparatus comprises at least one of at least one application PNF descriptor (PNFD-A) and at least one infrastructure PNF descriptor (PNFD-I) accessible by the management plane entity. Each PNFD-A and/or PNFD-I corresponds to at least one physical network function (PNF) for each network slice associated with the PNF. In some examples, a PNFD-A and a PNFD-I correspond to the same PNF.

In some examples, the management plane entity accesses data from the at least one PNFD-A to conFIG. the NF-A of the at least one PNF corresponding thereto.

In some examples, the PNFD-A is accessible by an EM/PNF manager (PNFM). In some examples, the EM/PNFM comprises at least one of the A-PM and the A-CM. In some examples, the A-CM generates an application configuration script for execution by the at least one NF-A of the PNF.

In some examples, the at least one NF-A provides inputs to the A-PM to support application-level CLA of the NF configuration of the PNF corresponding thereto.

In some examples, the management plane entity accesses data from the at least one PNFD-I to conFIG. the NF-I of the at least one PNF corresponding thereto.

In some examples, the PNFD-I is accessible by the EM/PNFM. In some examples, the EM/PNFM comprises at least one of an infrastructure performance manager for PNFs (PNF PM) and an infrastructure configuration manager for PNFs (PNF CM). In some examples, the PNF CM generates an infrastructure configuration script for execution by the at least one NF-I of the PNF corresponding thereto.

In some examples, the at least one NF-I provides inputs to the PNF PM to support infrastructure-level CLA of the NF configuration of the PNF corresponding thereto.

In an example, there is disclosed a method for managing an NF entity in a network slice instance, comprising, at an MF entity in a management plane of the network slice instance, accessing at least one DE in the management plane that each DE describes deployment and operational behaviour of the NF entity including at least one DE that relates to the network slice instance; and issuing a request to update a configuration of the NF entity in accordance with policy in the accessed DEs.

The method can include the action of obtaining performance feedback information from the NF entity regarding performance of the NF entity.

The request can be a request to scale resources allocated to the NF entity and/or to manage a configuration of the NF entity.

The action of accessing can include monitoring application-level performance of the NF entity at an A-PM component of the MF entity. The A-PM component can trigger an NM entity for accessing at least one DE that relates to an associated network slice instance.

The action of accessing can include monitoring infrastructure-level performance of the NF entity at an infrastructure performance manager component of the MF entity. The infrastructure performance manager component can form part of a VNFM in a MANO module. The infrastructure performance manager component can trigger an NM entity for accessing at least one DE that relates to an associated network slice instance.

The configuration can be updated by updating a configuration script to conFIG. the NF entity in accordance with policy in the accessed DEs. The configuration script can be an application configuration script to conFIG. an NF-A entity.

The method can include obtaining feedback information from the NF-A entity regarding application-level performance of the NF entity.

The action of accessing can be performed by an A-CM component and the A-CM component can update the configuration script.

The configuration script can be an infrastructure configuration script to conFIG. an NF-I entity.

The method can include obtaining feedback information from the NF-I entity regarding infrastructure-level performance of the NF entity.

The action of accessing can be performed by an infrastructure configuration manager component and the infrastructure configuration manager component can update the configuration script. The infrastructure configuration manager component can form part of a VNFM component in a MANO module.

The NF entity can be selected from a VNF entity and/or a non-virtualized PNF entity.

In an example, there is disclosed a node in a MF entity in a management plane of a network slice instance having a processor and a memory containing an MF software module that causes the MF entity to manage an NF entity in the network slice instance by accessing at least one DE in the management plane that each DE describes deployment and operational behaviour of the NF entity including at least one DE that relates to the network slice instance and issuing a request to update a configuration of the NF entity in accordance with policy in the accessed DE(s).

The computer program instructions can further cause the MF entity to obtain performance feedback information from the NF entity regarding performance of the NF entity.

### DESCRIPTION

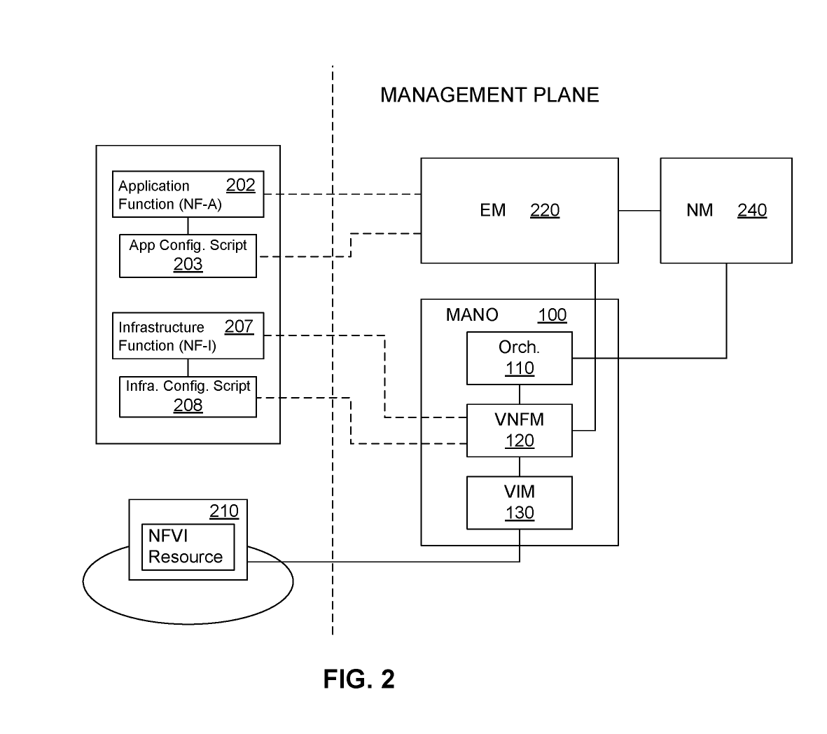

FIG. 2 is a block diagram showing an example of MFs in the management plane that may be used in the configuration of a VNF 200 in the network.

In some examples, the VNF 200 comprises an NF-A 202, an application configuration script or policy 203, an NF-I 207 and an infrastructure configuration script or policy 208.

The NF-A 202 manages application-level functionality of the VNF 200 in accordance with directions and/or criteria set out in the application configuration script 203. By way of non-limiting example, the NF-A 202 may provide a session management function (SMF) and/or a user-plane function (UPF).

The application configuration script 203 may comprise application-level parameters and workflows for the NF-A 202, for example, without limitation, load balancing settings, redundancy mode settings and/or IP addresses.

The NF-I 207 manages the functionality of the infrastructure allocated to or used by the VNF 200, in accordance with directions and/or criteria set out in the infrastructure configuration script 208. By way of non-limiting example, the NF-I 207 may provide an operating system (OS) function and/or a hypervisor function.

The infrastructure configuration script 208 may comprise infrastructure-level parameters and workflows for the NF-I 207, for example, without limitation, resource allocation and/or partitioning settings.

The VNF 200 may access infrastructure drawn from an NFV infrastructure (NFVI) resource 210 under direction of the VIM 130.

The MFs that are used in the configuration of the VNF 200 include the MANO 100, an EM 220 and/or an NM 240.

The EM 220 manages application-level behaviour of one or more VNFs 200. In some examples, each VNF 200 is supported by a separate EM 220. In some examples, a plurality of VNFs 200 may be supported by a common EM 220. In some examples, the EM 220 provides application-level performance indicators to the NM 240 of all VNF(s) 200 under its supervision. In some examples, the EM 220 provides application-level performance triggers to the VNFM 120 to cause the VNFM 120 to modify the infrastructure configuration script 208.

The NM 240 is responsible for managing and overseeing the NF(s) in a network service and for managing the overall application-level performance of the network. The NM 240 is also responsible for ensuring that network-level policies and/or workflows are translated into commands and/or actions implemented by individual NF(s), so that customer demands subscribing to the supported network services are satisfied.

The EM 220 updates the application-level parameters and/or workflows in the application configuration script 203 for the NF-A 202. In some examples, the EM 200 updates parameters and/or workflows based on inputs from the NF-A 202. By way of non-limiting example, the NF-A 202 may provide key performance indicators (KPIs) to the EM 220 and the EM 220 may update an internal state characterizing the behaviour of the NF-A 202 and may decide to modify the application configuration script 203 to modify the application-level functionality of the NF-A 202.

The VNFM 120 updates the infrastructure-level parameters and/or workflows in the infrastructure configuration script 208 for the NF-I 207. In some examples, the VNFM 120 updates parameters and/or workflows based on inputs from the NF-I 207. By way of non-limiting example, the NF-I 207 may provide KPIs to the VNFM 120 and the VNFM 120 may update an internal state characterizing the behaviour of the NF-I and may decide to modify the infrastructure configuration script 208 to modify the infrastructure-level functionality of the NF-I 207.

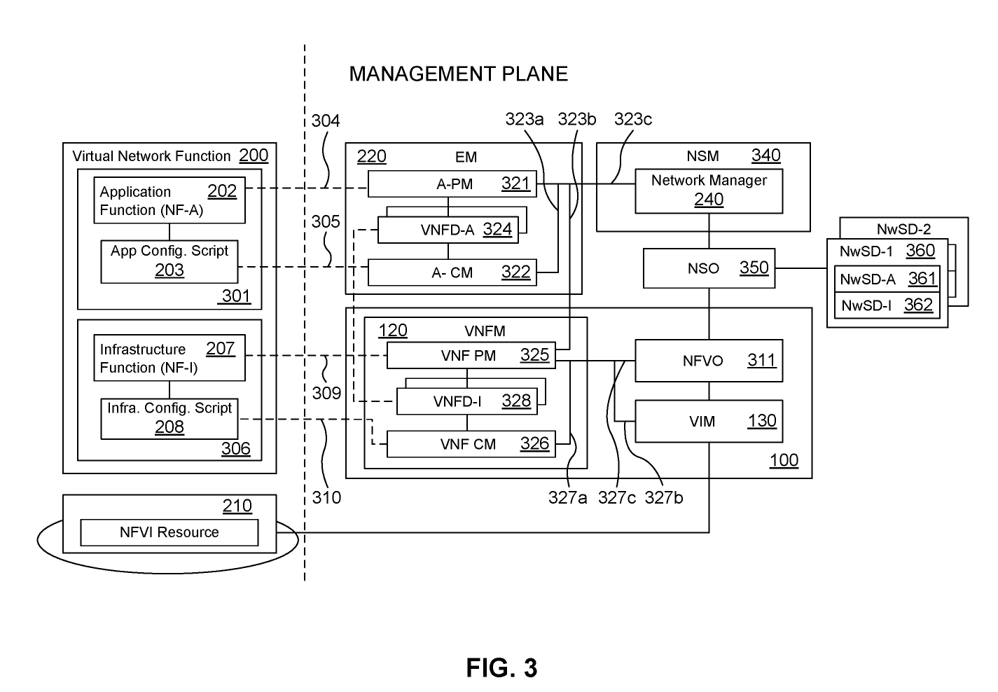

FIG. 3 is a block diagram similar to FIG. 2 but showing additional components including MFs in the management plane to support configuration of the VNF 200 in the network.

In an example, the VNF 200 is shown with an application component 301 that is decoupled from an underlying infrastructure component 306. This facilitates automation of the management of the application component in an infrastructure-agnostic manner. Similarly, automation of the management of the infrastructure can be managed in an application-agnostic manner. Still further, decoupling the application component from the underlying infrastructure facilitates integration of PNFs as part of the automation framework.

In this context, “application” refers to functionality implemented by NFs and should not be confused with the meaning of “application” in the context of 3GPP SA5, in which the term refers to functionality supported in the core network, including control plane functions and user plane functions. Non-limiting examples of control plane functions include access and mobility management functions (AMF) and/or SMFs. Non-limiting examples of user plane functions include serving as an mobility anchor and/or an IP anchor.

In this context, “infrastructure” refers to deployment aspects of NFs, including without limitation, resource configuration and/or partitioning.

The application component 301 may comprise the NF-A 202 and the application configuration script 203. Similarly, the infrastructure component 306 may comprise the NF-I 207 and the infrastructure configuration script 208.

In FIG. 3, the MFs also reflect decoupling of aspects related to the application component 301 from aspects related to the infrastructure component 306 of the VNF 200.

In the decoupled environment, the EM 220 is focused on management of the application component 301. As such, the EM 200 comprises an A-PM 321 and an A-CM 322. The EM 220 also comprises at least one VNFD-A 324.

The A-PM 321 is responsible for monitoring the application level performance of the NF-A 202. In some examples, the A-PM 321 receives information 304 from the NF-A 202 in a closed loop feedback mechanism to modify resource allocation at run-time in support of CLA of LCM and/or CM.

Additionally, the A-PM 321 triggers 323a an update 305 of the application configuration script 203 by the A-CM 322 in accordance with attributes and/or policies specified in one or more VNFDs-A 324. Further, the A-PM 321 may, in some examples, trigger 323b the VNF PM 325 to modify infrastructure resources in the NF-I 327 allocated to the NF-A 202 (by an update 310 of the infrastructure configuration script 208 by the VNFM CM 326 as described below). Still further, the A-PM 321 may, in some examples, provide 323c application-level performance and/or KPI report(s) to the NM 240.

The A-CM 322 is responsible for evaluating update requests 323a from the A-PM 221 and for configuring 305 the parameters in the application configuration script 303 for the NF-A 202 in accordance with attributes and/or policies specified in one or more VNFDs-A 324.

The VNFD-A 324 is a DE that comprises a template that describes the deployment and/or operational behaviour of the NF-A 202 of the VNF 200. The VNFD-A 324 contains application-level attributes and/or policy that may contain slice-specific customization and/or preferences. In some example embodiments, such as when the VNF 200 is specific to a given network slice instance, there may be a VNFD-A 324 for each slice instance associated with the VNF 200.

In the decoupled environment, the VNFM 120 is focused on management of the infrastructure component 306. As such, the VNFM 120 comprises a VNF PM 325 and a VNF CM 326. The VNFM 120 also comprises at least one VNFD-I 328.

The VNF PM 325 is responsible for monitoring the infrastructure-level performance of the VNF 200. In some examples, the VNF PM 325 receives information 309 from the NF-I 307 in a closed loop feedback mechanism to modify resource allocation at run-time in support of CLA of LCM and/or CM.

Additionally, the VNF PM 325 triggers 327a an update 310 of the infrastructure configuration script 308 by the VNF CM 326 in accordance with attributes and/or policies specified in one or more VNFDs-I 328. Further, the VNF PM 325 may, in some examples, provide 327b infrastructure-level performance and/or KPI report(s) and/or trigger(s) to modify resource allocation to the VIM 130. Still further, the A-PM 321 may, in some examples, provide 328c application-level performance and/or KPI report(s) and/or trigger(s) to modify resource allocation to the NFVO 311.

The VNF CM 326 is responsible for evaluating update requests 327a from the VNF PM 325 and for configuring 310 the parameters in the infrastructure configuration script 308 for the VNF 200 in accordance with attributes and/or policies specified in one or more VNFDs-I 328.

The VNFD-I 328 is a DE that comprises a template describing the deployment and/or operational behaviour of the NF-I 307 of the VNF 200. The VNFD-I 328 comprises infrastructure level attributes and/or policy that may contain slice-specific customization and/or preferences. In some example embodiments, such as when the VNF 200 is specific to a certain network slice instance, there may be a VNFD-I 328 for each slice instance associated to the VNF 200.

While the VNFD-A 324 and the VNFD-I 328 are shown as separate entities to emphasize the decoupled environment, in some examples, there may be a single VNFD entity (not shown) that comprises both the VNFD-A 324 and the VNFD-I 328. This is symbolized by the dashed line interconnecting the VNFD-A 324 and the VNFD-I 328.

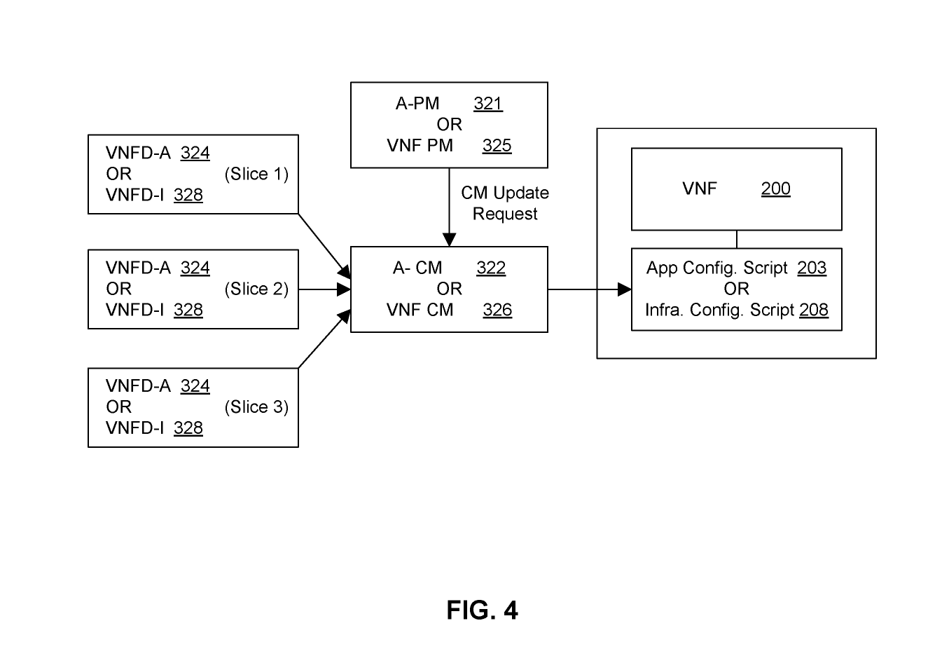

As shown in FIG. 4, where multiple slice instances are supported by a common VNF 200, the application configuration script 303 (or infrastructure configuration script 308) is conFIG.d by the A-CM 322 (or VNF CM 326) in response to a CM Update request 400 from the A-PM 321 (or VNF PM 325) after considering the applicable VNFDs-A 324 (or VNFDs-I 328) to ensure that there is no negative impact to any slice instance.

Referring back to FIG. 3, the MFs may in some examples may comprise the MANO 100, a Network Slice Manager (NSM) 340, and/or a Network Slice Orchestrator (NSO) 350.

The MANO 100 may comprise an NFV Orchestrator (NFVO) 311 instead of the Orchestrator 110, as well as the VNFM 120 and the VIM 130. The NFVO 311 performs LCM of network services.

The NSM 340 performs similar functions to the NM 230 but in the context of a network slicing environment and in some examples comprises one or more NMs 230.

The NSO 350 performs similar functions to the Orchestrator 110, namely LCM of network slice instances, but in the context of a network slicing environment. More specifically, the NSO 350 provides network slice-related transitions and/or configurations to the NFVO 311. These include the use of common and slice-specific NF(s) within the network slice instances. The NSO 350 operates under direction of the NSM 340 and in conjunction with the NFVO 310 and in accordance with the contents of at least one appropriate network slice DE (NwSD) 360.

Each NwSD 360 is a DE that comprises a template that contains a set of attributes and/or policies that describe the deployment and/or operational behaviour of an associated network slice instance. The NwSD 360 may describe inter-dependencies between VNFs 200. In some examples, there is an NwSD 360 corresponding to each network slice instance. The multi-dimensional NwSD 360 is structured and isolated such that any modification to the configuration applicable to a common VNF 200 will not negatively impact any network slice instance.

In some examples, each NwSD 360 may comprise an application portion (NwSD-A) 361 and/or an infrastructure portion (NwSD-I) 362. Such a structure facilitates the decoupled management of the NF-A 202 and the underlying NF-I 208.

### Policies

In this context, policy refers to a set of rules and/or conditions that enable the MFs to assess and evaluate the triggering events in a network slice and to take actions appropriate thereto in response. Such policy is used to guide the behaviour of the VNFs 200 and to drive automated provisioning of resources and configurations in accordance with hosted service demands. Policy enforcement can be implemented at either or both of a distributed (VNF) level and at a centralized (network slice instance) level.

In some examples, the policies are specified in the DEs (VNFD-A 324, VNFD-I 328, NwSD-A 361, NwSD-I 362) and put into effect by configuring parameters into the application configuration script 303 and/or the infrastructure configuration script 308.

In some examples, the application configuration script 303 can contain configuration parameters used by the NF-A 302 such as, without limitation, load balancing settings, redundancy mode settings and/or IP addresses under policies specified in applicable VNFDs-A 324.

In some examples, the infrastructure configuration script 308 can conFIG. parameters in the NF-I 307 such as, without limitation, compute, storage and/or network resource allocations and/or bounds under policies specified in applicable VNFDs-I 328.

The existence of isolated slice-specific VNFDs-A 324 and/or VNFDs-I 328 facilitates CM to be performed in common VNFs 200 shared by multiple slice instances while taking into account considerations and awareness of the impact on individual slice instances.

There are a number of policy attributes that define an automation policy. Such attributes comprise one or more of triggering events, rules and/or actions. Such attributes are generally dependent upon the functionality of the VNF 200 in terms of the NF-A 202 and the service(s) hosted by the network slice instances. As such, policy attributes can be characterized as being application-specific (that is, attributes that are related to applications) and application-agnostic (that is, attributes that are related to the underlying infrastructure).

Triggering events are based on changes in the operational state of the VNF 200. As such, they can originate from the NF-A 202 (by way of non-limiting example, an AMF desires to connect to a new SMF) as information 304, from the NF-I 207 (by way of non-limiting example, the NF-I 207 detects a surge in the load condition) as information 309, or even from within the MFs, based upon internal tracking performed by the NwSDs 360 (by way of non-limiting example, the EM 220 can track a schedule specified in a VNFD-A 324 using an internal timer and trigger a scheduled operation). The events may be monitored by rules in the A-PM 321 and/or VNF PM 325 and/o generate corresponding actions for LCM and/or CM.

Rules define a set of conditions that map triggering events to an action. Such conditions may be static or may be changeable (adaptable based on a learning mechanism and/or construction of a model). The A-PM 321 and A-CM 322 analyze the application-related rules stored in the VNFDs-A 324 and generate 305 one or more corresponding actions for LCM and/or CM in the application configuration script 303 for implementation by the NF-A 302. The VNF PM 325 and VNF PM 326 analyze the infrastructure-related rules stored in the VNFDs-I 328 and generate 310 one or more corresponding actions for LCM and/or CM in the infrastructure configuration script 308 for implementation by the NF-I 307.

Actions comprise items in the application configuration script 303 and/or infrastructure configuration script 308 that primarily consist of LCM and/or CM update requests. LCM update requests deal with requests to scale (up/down and/or in/out) resources and are targeted toward the A-PM 321 (in the context of application-related LCM) and the VNF PM 325 (in the context of infrastructure-related LCM). CM update requests deal with other changes in the configuration of the application configuration script 303 that are targeted toward the A-CM 322 and/or infrastructure configuration script 308 that are targeted toward the VNF CM 326.

Actions can be generated within the EM 220 and/or VNFM 120, whether reactively by triggering of events, and/or proactively by analyzing rules in the VNFDs-A 324 and/or VNFDs-I 328. In some examples, actions can be generated within the NSM 340, which may monitor performance at a network slice level reactively through the EM 220 or proactively through the VNFM 220. In response, the NSM 340 may generate actions by triggering events and/or have events triggered in accordance with rules and/or schedules in the NwSD(s) 360 accessed by the NSM 340 through the NSO 350. In some examples, actions are generated while one or more network slices are created. In some examples, actions are generated while one or more network slice instances are being modified.

### Non-Virtualized NFs

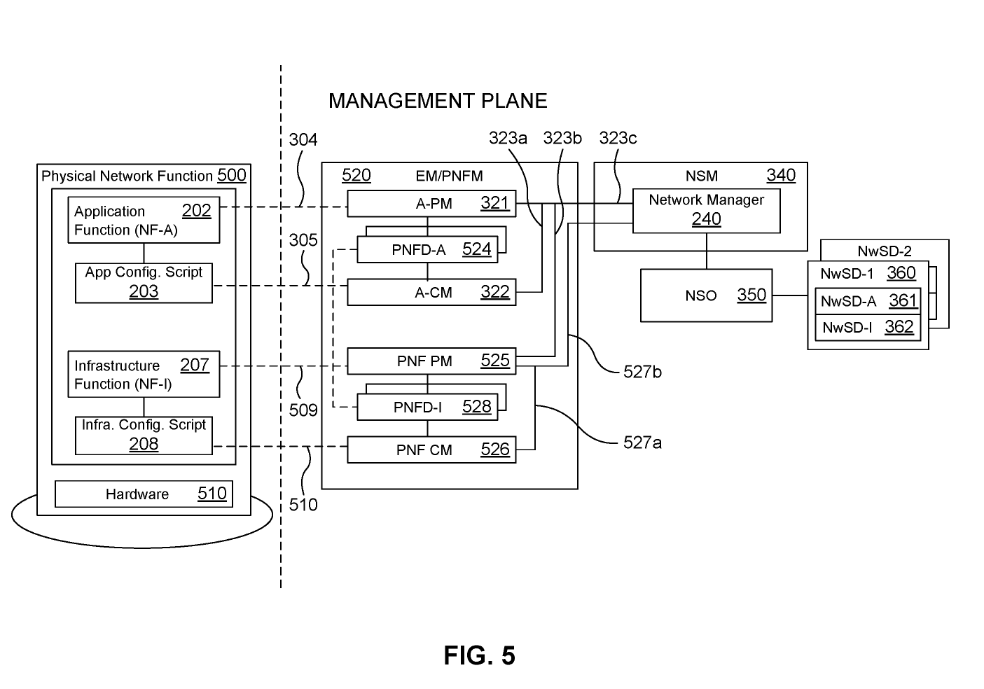

FIG. 5 is a block diagram similar to FIG. 3 but showing MFs to support configuration of a PNF 500.

The PNF 500 is shown in a decoupled structure, comprising an NF-A 202, an application configuration script 203, an NF-I 207, an infrastructure configuration script 208 and certain hardware 510. Like the VNF 200, the NF-A 303 provides the functionality of the PNF 500 in accordance with directions and/or criteria set out in the application configuration script 303 and the NF-I 307 manages the functionality of hardware 510 allocated to or used by the PNF 500, in accordance with directions and/or criteria set out in the infrastructure configuration script 308.

Unlike in the case of FIG. 2, the NF-A 202 and the application configuration script 203 are not shown as part of an application component 301 and the NF-I 207 and the infrastructure configuration script 208 are not shown as part of an infrastructure component 302. As discussed below, both the application-level and infrastructure-level functions are managed by a common entity (EM/PNFM 520). In some examples, the greater flexibility obtained by decoupling of the application component 301 and the infrastructure component 302 could also be applied to the PNF 500.

In FIG. 5, components of the EM 220 are combined with components of the VNFM 120 to form an EM/PNF manager (PNFM) 520. The EM/PNFM 520 thus comprises the A-PM 321, A-CM 322, at least one PNFD-A 524, a PNF PM 525, a PNF CM 526 and/or at least one PNFD-I 528.

The PNFD-A 524 is a DE that comprises a template that describes the deployment and/or operational behaviour of the NF-A 302 of the PNF 500. The PNFD-A 524 contains application-level attributes and/or policy that may contain slice-specific customization and/or preferences. In some example embodiments, such as when other VNFs 200 associated with the PNF 200 support network slicing, there may be a PNFD-A 524 for each slice instance supported by the associated VNF(s) 200.

The PNF PM 525 is responsible for monitoring the infrastructure-level performance of the PNF 500. In some examples, the PNF PM 525 receives information 509 from the NF-I 307 in a closed loop feedback mechanism to modify resource allocation at run-time in support of CLA of LCM and/or CM. Additionally, the PNF PM 525 triggers 527a an update of the infrastructure configuration script 308 by the PNF CM 526 in accordance with attributes and/or policies specified in one or more PNFDs-I 528. Further, the PNF PM 525 may in some examples provide 527b infrastructure-level performance and/or KPI report(s) and/or trigger(s) to modify resource allocation to the NM 240.

The PNF CM 526 is responsible for evaluating update requests 527a from the PNF PM 525 and for configuring 510 the parameters in the infrastructure configuration script 308 for the PNF 500.

The PNFD-I 528 is a DE that comprises a template describing the deployment and/or operational behaviour of the NF-I 307 of the PNF 500. The PNFD-I 528 comprises infrastructure-level attributes and/or policy that may contain slice-specific customization and/or preferences. In some example embodiments, such as when other VNFs 200 and/or PNFs 500 associated with the PNF 500 support network slicing, there may be a PNFD-I 528 for each slice instance supported by the associated PNF 500.

In FIG. 5, because the PNF 500 is not virtualized, there is no VNFM 120 or MANO 100. Rather, as discussed above, the components of the VNFM 120 have been combined with the components of the EM 220 to form a composite EM/PNFM 520. The equivalent functions and/or the components of the MANO 100 have been subsumed in the NM 240.

Referring back to FIG. 4, it will be appreciated that references therein to the VNF 200, VNF PM 325, VNF CM 326, VNFD-A 324 or VNFD-I 328 may be read, in light of FIG. 5, as a reference to the PNF 500, PNF PM 525, PNF CM 526, PNFD-A 524 and/or PNFD-I 528 respectively.

### EXAMPLES

In the non-limiting examples that follow in the present disclosure, certain automation processes are shown.

Where an example may refer to an application-level construct in the preceding FIG.s, such as an application component 301, NF-A 302, application configuration script 303, information 304, update 305, A-PM 321, A-CM 322, trigger 323a, 323b, 323c, VNFD-A 324 or NwSD-A 361, in appropriate circumstances, such example may be understood to apply, instead or in addition, to a comparable infrastructure-level construct in the preceding FIG.s, such as an infrastructure component 306, NF-I 307, infrastructure configuration script 308, information 309, update 310, VNF PM 325, VNF CM 326, trigger 327a, 327b, 327c, VNFD-I 325 or NwSD-I 362 respectively.

Similarly, where an example may refer to a VNF construct in the preceding FIG.s, such as a VNF 200, information 309, update 310, EM 220, VNFD-A 324, VNFM 120, VNF PM 325, VNF CM 326, trigger 327a, 327b, 327c, VNFD-I 325 or MANO 100, in appropriate circumstances, such example may be understood to apply, instead or in addition, to a comparable PNF construct in the preceding FIG.s, such as a PNF 500, information 309, update 510, EM/PNFM 520, PNFD-A 524, EM/PNFM 520, PNF PM 525, PNF CM 526, trigger 527a, 527b, PNFD-I 525 or NSM 340 respectively.

### Automation

The present disclosure contemplates both a closed-loop feedback mechanism and an open-loop policy-driven automation mechanism for LCM and/or CM.

CLA may be applicable when network operation is impacted by dynamic and/or non-deterministic factors, such as, without limitation, fluctuations in traffic load and/or user equipment (UE) mobility. In some examples, CLA is applicable for network slices whose supported services have no pre-defined and/or non-deterministic service attributes, such as, by way of non-limiting example, an enhanced mobile broadband (e-MBB) and/or ultra-reliable and low latency communications (URLLC) slice with no pre-defined UE transmission schedule.

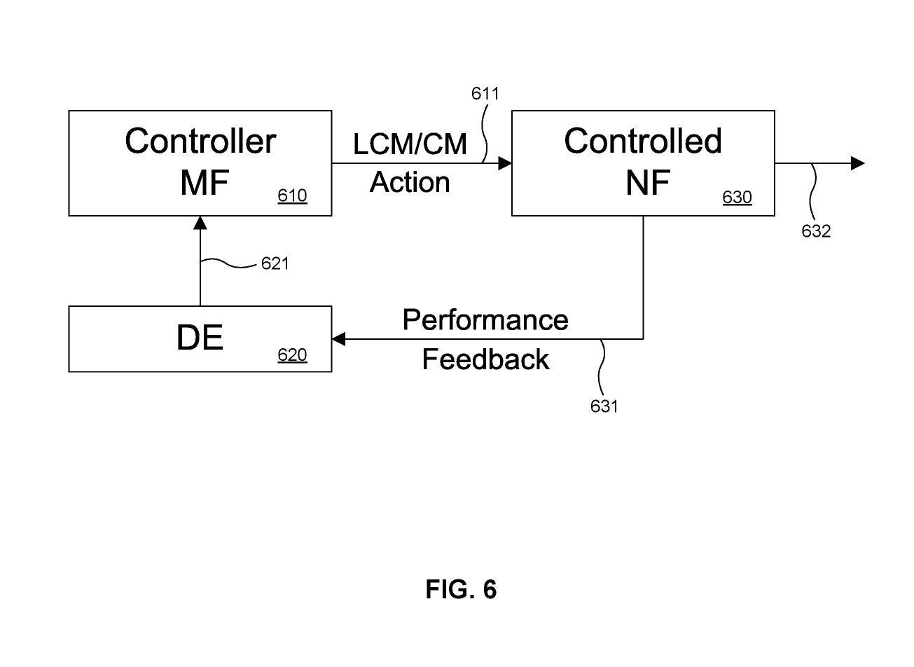

In such circumstances, such as is shown in FIG. 6, which describes an example processing flow of a CLA action, the controller MF 610 can monitor, through a DE 620, performance feedback 631 to modify the resource allocation at run-time. By way of non-limiting example, the performance feedback 631 may be information 304 from the NF-A 302, such as NF performance-related indicators including, without limitation, resource usage and/or application KPIs.

The controller MF 610 makes use of policy(ies) 621 specified in and accessed by the controller MF 610 from DEs 620 to generate an action 611 to update the LCM and/or CM of the controlled NF 630. The DE 620 records the performance feedback 631 and provides enhanced information derived therefrom to the controller MF 610 through the policies 621. This enhanced information may include, without limitation, filtered signal(s) and/or threshold-induced trigger(s). In some examples, the action 611 may be an update 305 of the application configuration script 303 of the controlled NF 630.

From time to time, the controlled NF 630 may provide a response or behaviour change 632 as a result of the LCM/CM action 611. This response may be provided to other NF(s) (not shown) or other MF(s) (not shown).

In some examples CLA is performed iteratively until a desired performance level or a desired state of the controlled NF 630 is attained.

OLA may be applicable when all operational states of the VNF 200 are well-defined and predictable. In some examples, OLA is applicable for network slice instances whose supported services have pre-defined and/or predictable service attributes, such as, by way of non-limiting example, a massive machine type communication (mMTC) slice with a pre-defined device transmission schedule.

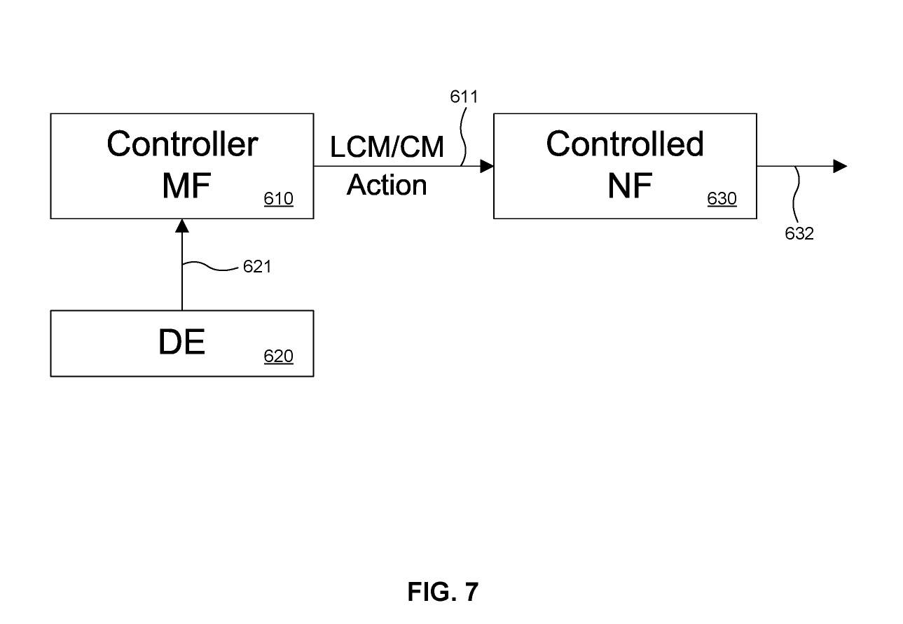

In such circumstances, such as is shown in FIG. 7, which describes an example processing flow of an OLA action, the controller MF 610 makes use of polic(ies) 621 to generate an action 611 to update the LCM and/or CM of the controlled NF 630.

In some examples, OLA is performed proactively to change the NF 630 to a desired state in accordance with a pre-defined rule in the DE 620. In some examples, OLA is performed reactively in response to a pre-defined rule in the DE 620 to change the NF 630 to a desired state.

From time to time, the controlled NF 630 may provide a response or to behaviour change 632 as a result of the LCM/CM action 611. This response may be provided to other NF(s) (not shown) or other MF(s) (not shown).

The process of automation, whether by CLA or by OLA, can involve auto-scaling, auto-configuration, on-demand scaling and/or on-demand configuration.

In this context:
auto-scaling comprises a mechanism driven by internal DEs 620, that is, a DE 620 specific to a given controlled NF 630, for automatically scaling resources allocated to the controlled NF 630;
auto-configuration comprises a distributed mechanism driven by internal Des 620 for automatically updating the application configuration script 303 of a controlled NF 630;
on-demand scaling comprises a mechanism driven by external DEs 620, that is, a DE 620 that is not specific to a given controlled NF 630, for scaling resources allocated to the controlled NF 630 based on an externally generated LCM update request; and
on-demand configuration comprises a mechanism driven by external DEs 620 for updating the application configuration script 303 of a controlled NF 630 based on an externally-generated CM update trigger.

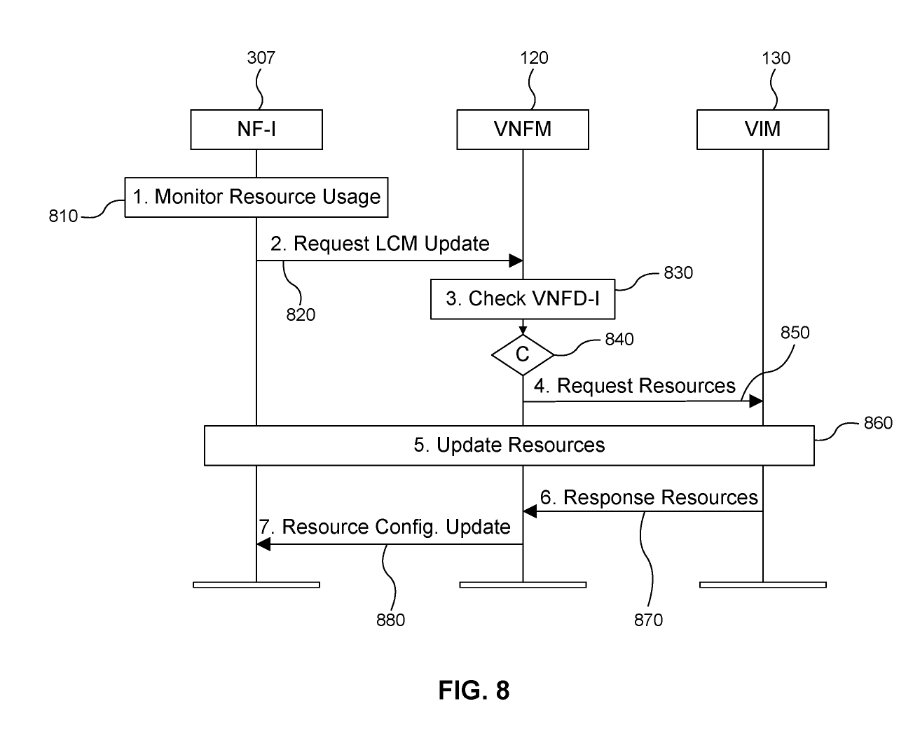

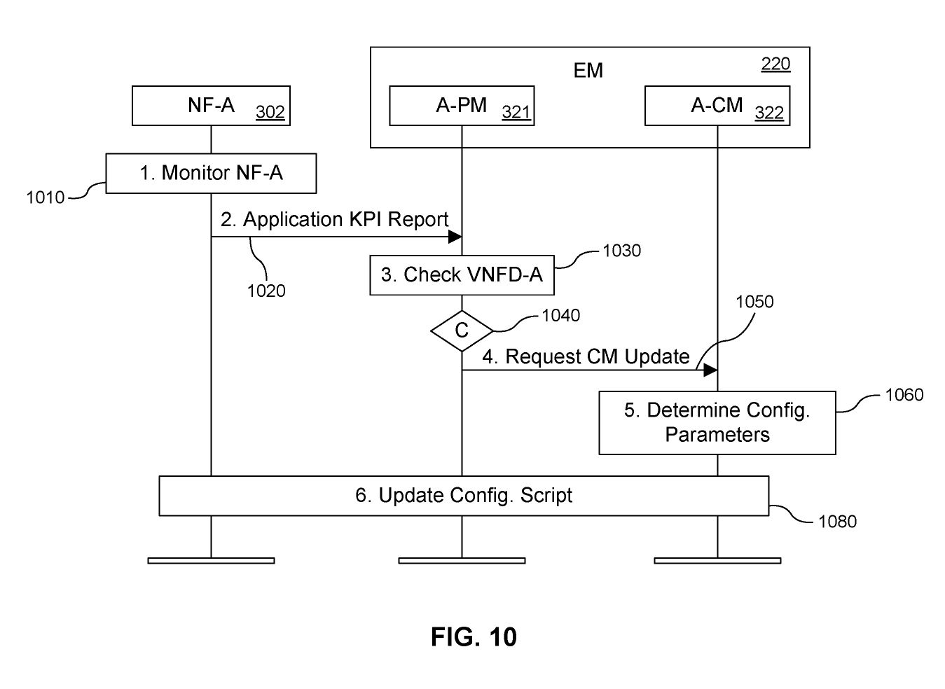

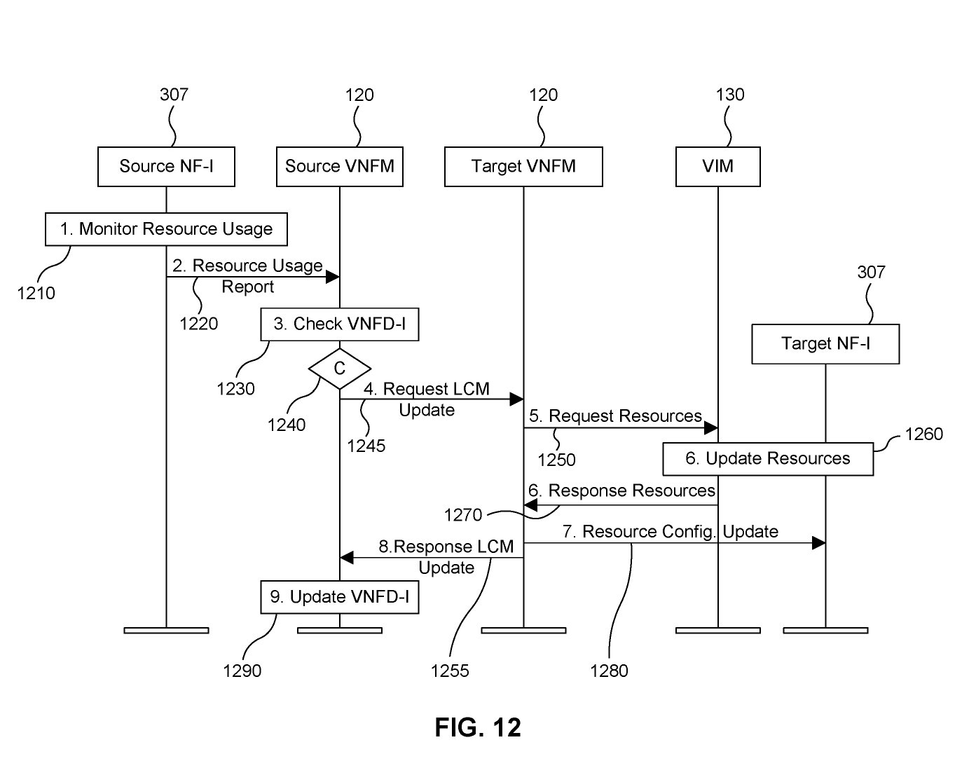

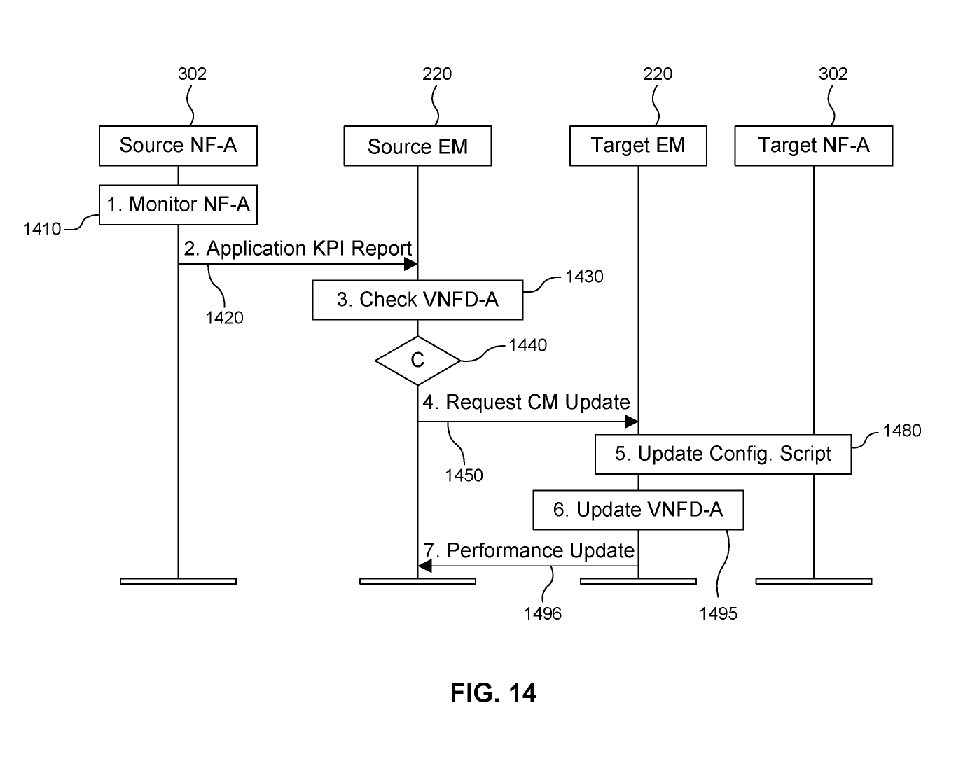

The CLA 328 processing of FIG. 6 is described below in the context of examples of auto-scaling (FIG. 8), auto-configuration (FIG. 10), on-demand scaling (FIG. 12) and on-demand configuration (FIG. 14).

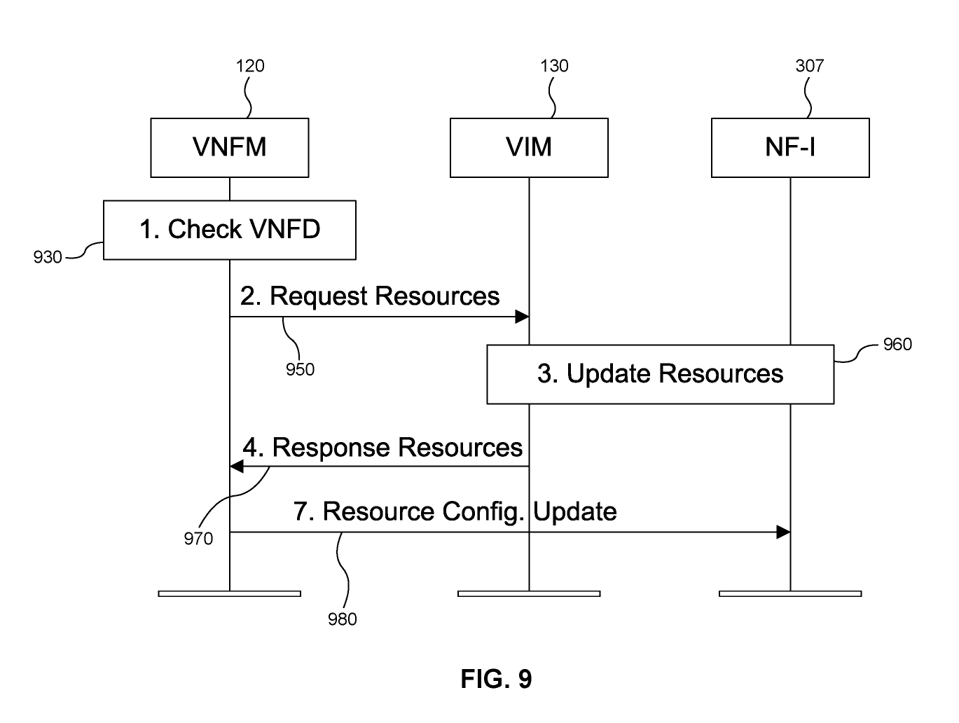

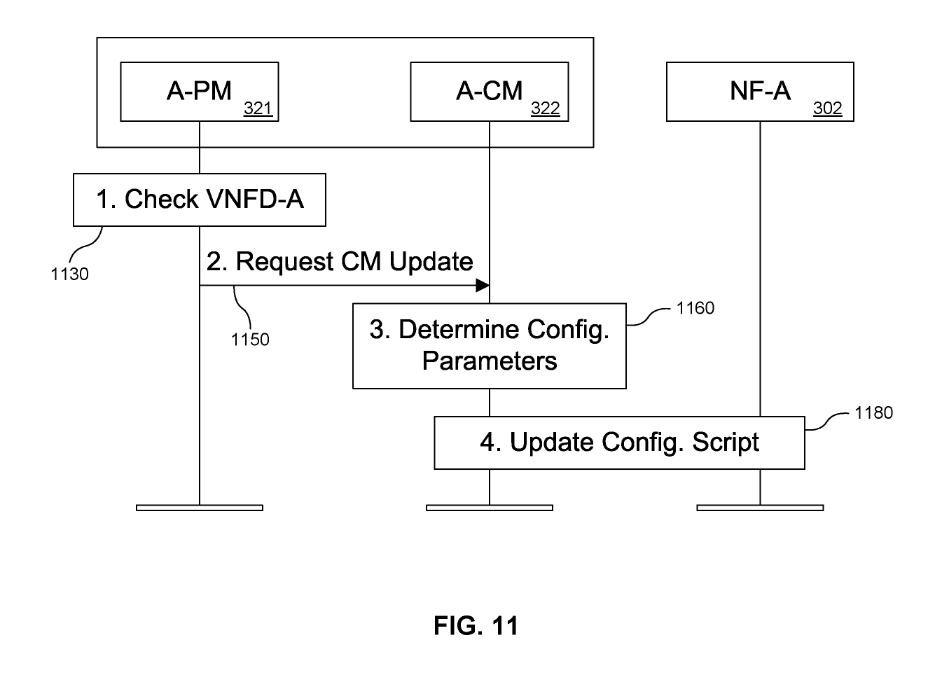

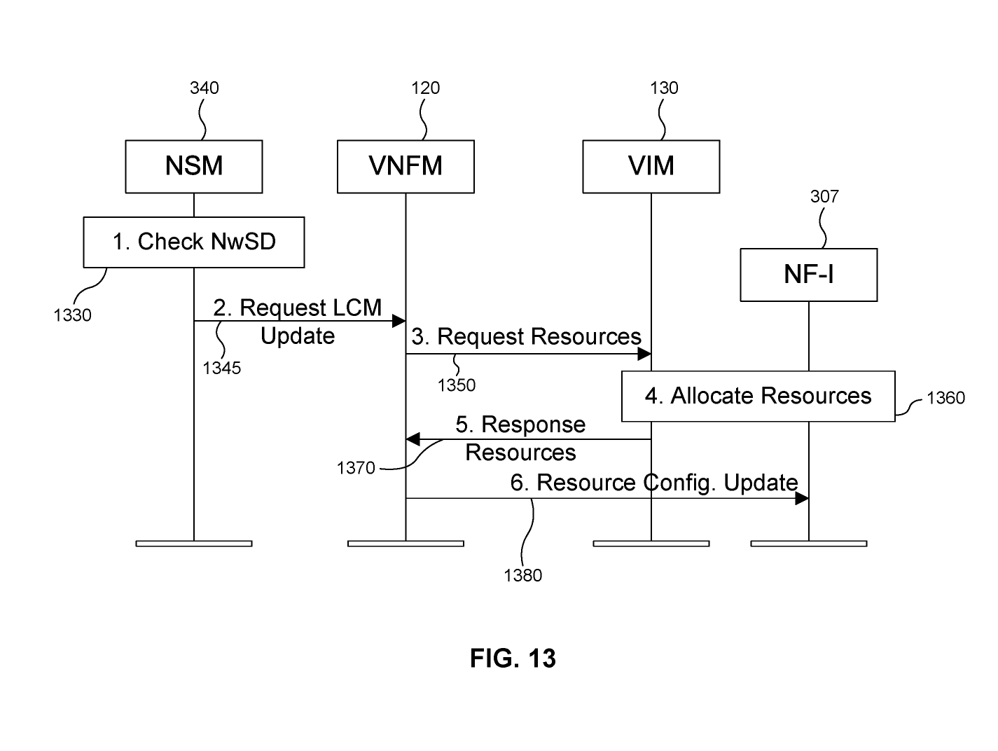

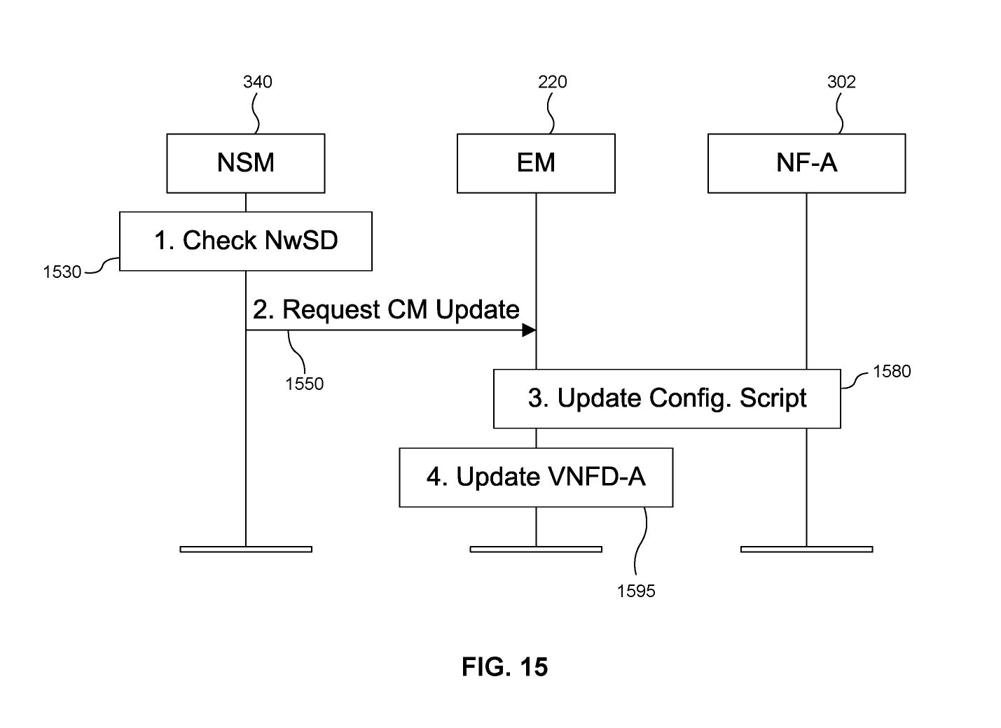

The OLA processing of FIG. 7 is described below in the context of examples of auto-scaling (FIG. 9), auto-configuration (FIG. 11), on-demand scaling (FIG. 13) and on-demand configuration (FIG. 15).

### CLA Auto-Scaling

In CLA auto-scaling, the resources are iteratively scaled based on monitoring of resource utilization.

FIG. 8 shows an example message flow diagram illustrating CLA auto-scaling. In the example, the controlled NF 630 in the processing of FIG. 6 is the NF-I 307 of the infrastructure portion 306 of the VNF 200. The NF-I 307 monitors 810 the usage of the NFVI resource 210. This monitoring can occur periodically or based upon certain resource update events (such as, without limitation, load surge).

If a resource update condition, as specified in the infrastructure configuration script 308 is satisfied, an LCM update request (the performance feedback 631 in the processing of FIG. 6) is triggered 820 to the VNFM 120 (the controller MF 610 in the processing of FIG. 6.

The LCM update request may request a specific amount of NFVI resources 210 and may be in the form of a request for an action to scale up or down (that is, update the allocated NFVI resources 210) or to scale in or out (that is, to update the number of virtualized instances).

The VNFM 120 checks 830 (the flow 621 in the processing of FIG. 6) the VNFD-I 328 (the DE 620 in the processing of FIG. 6) and evaluates 840 whether or not to trigger a resource request based on rules set out in the VNFD-I 328. If auto-scaling is called for, the VNFM 120 signals 850 to the VIM 130 to allocate and/or terminate NFVI resources 210, whereupon the VIM 130, NF-I 307 and the VNFM 120 update 860 their respective statuses to reflect the update in the resource allocation in the NFVI 210.

The VIM 130 sends a response 870 to the resource request 850 to the VNFM 120, whereupon the VNFM 120 sends 880 a resource configuration update (or acknowledgment) that the resources have been updated (the LCM/CM action 611 in the processing of FIG. 6) to the NF-I 307.

As CLA auto-scaling may in some examples be an iterative process, the disclosed message flows may repeat until the performance of the VNF 200 converges to a desired level.

The details described herein in respect of CLA auto-scaling is comparable and similar to the details provided in ETSI-NFV-SWA-001 (Network Function Virtualization: VNF Architecture).

### OLA Auto-Scaling

In OLA auto-scaling, the resources are scaled based on tracking of the service conditions and/or schedule specified in the VNFDs-A 324.

FIG. 9 shows an example message flow diagram illustrating OLA auto-scaling. A non-limiting example scenario may be an mMTC slice hosting an MTC service with scheduled transmission of devices.

In the example, the VNFM 120 is the controller MF 610 in the processing of FIG. 7.

The VNFM 120 tracks conditions 930 (the flow 621 in the processing of FIG. 7) such as, by way of non-limiting example, a resource update schedule, in the VNFD-I 328 (the DE 620 in the processing of FIG. 7) and generates a request 950 to the VIM 130 to allocate or terminate NFVI resources 210 to scale up/down the resources 210 available to the VNF 200. The VIM 130 and the NF-I 307 (the controlled MF in the processing of FIG. 7) update 960 their respective statuses to reflect the update in resources 210.

The VIM 130 sends a response 970 to the resource request 920 to the VNFM 120, whereupon the VNFM 120 sends 980 a resource configuration update (the LCM/CM action 611 in the processing of FIG. 7) to the NF-I 307.

### CLA Auto-Configuration

In CLA auto-configuration, the application configuration script 303 is updated by the A-PM 321 and A-CM 322 of the EM 220 using CM update requests 323. Such CM update requests 323 may indicate the specific configuration parameters to be updated. The CM update requests 323 may be based on rules specified in applicable VNFDs-A 324.

FIG. 10 shows an example message flow diagram illustrating CLA auto-configuration. In the example, the NF-A 302 of the application component 301 of the VNF 200 is the controlled NF 630 in the processing of FIG. 6, such as, by way of non-limiting example, a newly-activated SMF.

A non-limiting example scenario may be similar to a bootstrapping process to conFIG. the controlled NF 630, in which there is no external triggering. By way of non-limiting example, the monitoring and configuration of the NF-A 202 is done 1010 in conjunction with the A-PM 321 and A-CM 322 in the EM 220 without any external trigger.

When the NF-A 302 has resource usage (the performance feedback 631 in the processing of FIG. 6) to report, it provides 1020, to the A-PM 321 of the EM 220 (the controller MF 610 in the processing of FIG. 6), an update to the application KPIs (such as, by way of non-limiting example, the loading of the context of one or more UEs).

The A-PM 320 checks 1030 (the flow 621 in the processing of FIG. 6) rule(s) in the VNFD(s)-A 324 of the EM 220 (the DE 620 in the processing of FIG. 6).

If the rule(s) indicate a CM update is called for 1040, the A-PM 320 triggers a request for a CM update 1050 to its associated A-CM 322 of the EM 220.

The A-CM 322 determines 1060 a set of configuration parameters corresponding to the CM update requested, such as, by way of non-limiting example, a mapping of UEs to subscriber data server addresses for all slice instances.

Based on the determined configuration parameters, the A-CM 322 updates 1080 the application configuration script 303 (the LCM/CM action 611 in the processing of FIG. 6) of the VNF 200.

As CLA auto-configuration may in some examples be an iterative process, the disclosed message flows may repeat until the controlled NF 630 is fully conFIG.d and updated.

The details described herein in respect of CLA auto-configuration enhances the details provided in ETSI-NFV-SWA-001.

### OLA Auto-Configuration

In OLA auto-configuration, the application configuration script 303 is updated by the A-PM 321 and A-CM 322 of the EM 220 using CM update requests 323 based on conditions specified in applicable VNFDs-A 324.

FIG. 11 shows an example message flow diagram illustrating OLA auto-configuration. A non-limiting example scenario may be an mMTC slice hosting a smart grid MTC service in which different UPF VNFs 200 (the controlled NF(s) 630 in the processing of FIG. 7) are to be conFIG.d to connect to a common application server, such that the connectivity correlates with a transmission schedule of serving devices (not shown) located at different locations.

The A-PM 321 of the EM 220 (the controller MF 610 in the processing of FIG. 7) manages a group of UPF VNFs 200.

The A-PM 321 checks 1130 (the flow 621 in the processing of FIG. 7) conditions in the VNFD(s)-A 324 of the EM 220 (the DE 620 in the processing of FIG. 7).

If the condition(s) indicate a CM update is called for, the A-PM 320 triggers a request for a CM update 1150 to its associated A-CM 322 of the EM 220.

The A-PM 322 determines 1160 a set of configuration parameters corresponding to the CM update requested.

Based on the determined configuration parameters, the A-CM 322 updates 1180 the application configuration script 303 (the LCM/CM action 611 in the processing of FIG. 7) of the UPF VNF(s) 200.

### CLA On-Demand Scaling

In CLA on-demand scaling, the scaling of resources is performed iteratively based on the external LCM update trigger, which is given higher precedence than any rules that may have been internally specified in the context of CLA auto-scaling in applicable VNFDs-I 328.

FIG. 12 shows an example message flow diagram illustrating CLA on-demand scaling. A non-limiting example scenario may be a SM VNF 200 (one of several controlled NFs 630 in the processing of FIG. 6) detecting a potential increase in traffic load handled by a corresponding UPF VNF 200 (the other controlled NF(s) in the processing of FIG. 6) based on application KPI monitoring, such as, by way of non-limiting example, a number of protocol data unit (PDU) session requests. In this context, the MF(s) associated with the (in the described example scenario) “source” SM VNF 200, are designated as “source” components while the MF(s) associated with the (in the described example scenario) “target” UPF VNF 200, are designated as “target” components.

In the example scenario, the NF-I 307 of the source SM VNF 200 monitors 1210 its conditions, such as, by way of non-limiting example, its resource usage. When it detects the potential increase in traffic load, it sends 1210 a resource usage report (the performance feedback 631 in the processing of FIG. 6) to the source VNFM 120.

The source VNFM 120 (one of several controller MFs 610 in the processing of FIG. 6) checks 1230 (the flow 621 in the processing of FIG. 6) rules, such as, by way of non-limiting example, NF dependency rules, in the VNFD(s)-I of the VNFM 120 (the DE 620 in the processing of FIG. 6).

If the rule(s) indicate an LCM update is called for 1240, the source VNFM 120 triggers a request for an LCM update 1245 to the target VNFM 120 (another of the controller MFs 610 in the processing of FIG. 6). The target VNFM 120 generates a request 1250 to the VIM 130 to allocate or terminate NFVI resources 210 to scale up/down the resources 210 available to the UPF VNF(s) 200 controlled by the target VNFM 120. The VIM 130 and the UPF VNF 200 update 1260 their respective statuses to reflect the update in resources 210.

The target VIM 130 sends a response 1270 to the resource request 1250 to the target VNFM 120, whereupon the target VNFM 120 sends 1280 a resource configuration update (the LCM/CM action 611 in the processing of FIG. 6) to the NF-I 307 of the corresponding UPF VNF 200.

Once the target UPF VNF 200 is conFIG.d with new resources 210, the target VNFM 120 sends a response 1255 to the LCM update 1245 to the source VNFM 120.

As CLA on-demand scaling is an iterative process, the disclosed message flows may repeat until the performance of the VNF 200 converges to a desired level.

The details described herein in respect of CLA on-demand scaling is comparable and similar to the details provided in ETSI-NFV-SWA-001.

### OLA On-Demand Scaling

FIG. 13 shows an example message flow diagram illustrating OLA on-demand scaling. A non-limiting example scenario may be a URLLC slice instance hosting a moving ambulance service. In such a scenario, the LCM of the UPF VNF(s) 200 (the controlled NF(s) 630 in the processing of FIG. 7) is performed by closely tracking the mobility of the ambulance. The NwSD 360 (the DE 620 in the processing of FIG. 7), accessed by the NFM 340 through the NSO 350, for the slice instance specifies the mobility path and/or the estimated duration that the ambulance will remain within the coverage of the UPGW VNF(s) 200.

The NSM 340 (one of several controller MFs 610 in the processing of FIG. 7) tracks 1330 (the flow 620 in the processing of FIG. 7) the conditions in the NwSD 360 and requests an LCM update 1345 at corresponding VNFM(s) 120 (the other controller MF(s) 610 in the processing of FIG. 7) supporting the UPF VNF(s) 200.

The VNFM(s) 120 supporting the UPF VNF(s) 200 generate a request 1350 to the associated VIM(s) 130 to allocate or terminate NFVI resources 210 to scale up/down the resources available to the UPF VNF(s) 200. The VIM(s) 130 and NF-I 307 of the UPF VNF(s) 200 update 1360 their respective statuses to reflect the update in resources 210.

The VIM(s) 130 send(s) a response 1370 to the resource request 1350 to the VNFM(s) 120, whereupon the VNFM(s) 120 send(s) 1380 a resource configuration update (the LCM/CM action 611 in the processing of FIG. 7) to the NF-I 307 of the UPF VNF(s) 200.

CLA On-Demand Configuration

In CLA on-demand configuration, the application configuration script 303 is iteratively updated by the A-PM 321 and A-CM 322 of the EM 220 using the externally generated CM update requests 323. Such CM update requests 323 may indicate the specification configuration parameters to be updated. The externally generated CM update requests 323 are given higher precedence than any rules that may have been specified in the context of internal CLA auto-configuration in applicable VNFDs-A 324.

FIG. 14 shows an example message flow diagram illustrating CLA on-demand configuration. A non-limiting example scenario may be a CriC slice hosting a URLLC service. In such a scenario, the source SM VNF 200 (one of several controlled NFs 630 in the processing of FIG. 6) attempts to conFIG. the parameters used at the transport layer protocol implemented at the target UPF VNF(s) (the other controlled NFs 630 in the processing of FIG. 6) based on the monitoring of service performance. Initially, the monitoring and configuration of the NF-A 302 of the source SMF VNF 200 is done 1410 in conjunction with the EM 220 without any external trigger.

When the NF-A 302 has resource usage to report, it provides 1420 an update to the application KPIs (the performance feedback 631 in the processing of FIG. 6) to the A-PM 321 of the source EM 220 (one of the controller MFs 610 in the processing of FIG. 6).

The A-PM 321 of the source EM 220 checks 1430 (the flow 620 in the processing of FIG. 6) rule(s) in the VNFD(s)-A 324 (one of the DEs 620 in the processing of FIG. 6) of the source EM 220.

If the rule(s) indicate a CM update is called for 1440, the A-PM 321 of the source EM 220 triggers a request for a CM update 1450 to the A-CM 322 of the target EM 220 (the other controller MF 610 in the processing of FIG. 6).

The A-CM 322 of the target EM 220 determines a set of configuration parameters corresponding to the CM update requested. Based on the determined configuration parameters, the A-CM 322 updates 1480 the application configuration script 303 (the LCM/CM action 611 in the processing of FIG. 6 of the target UPF VNF(s) 200.

Additionally, the A-CM 322 of the target EM 220 updates 1495 any record(s) and/or rule(s) in the VNFD(s)-A 324 of the target EM 220 that reflect any trace of the externally-generated CM update request 611 (another DE 620 in the processing of FIG. 6.

The A-PM 322 of the target EM 220 reports 1496 the performance of the target UPF VNF(s) 200 back to the A-PM 322 of the source EM 220 to facilitate further evaluation and subsequent CM updates.

As CLA on-demand configuration may in some examples be an iterative process, the disclosed message flows may repeat until the controlled NF 630 is fully conFIG.d and updated.

The details described herein in respect of CLA on-demand configuration enhances the details provided in ETSI-NFV-SWA-001.

OLA On-Demand Configuration

FIG. 15 shows an example message flow diagram illustrating OLA on-demand configuration. A non-limiting example scenario may be a URLLC slice instance hosting a mobile URLLC service. In such a scenario, the NwSD 360 (one of the DEs 620 in the processing of FIG. 7), accessed by the NFM 340 through the NSO 350, for the slice instance specifies the mobility path and/or the estimated duration in which the UE(s) remain within the coverage areas of the target UPF VNF(s) 200 (the controlled NF(s) in the processing of FIG. 7).

The NSM 340 (one of the controller MFs 610 in the processing of FIG. 7) tracks 1530 (the flow 620 in the processing of FIG. 7) the conditions in the NwSD 360, such as, by way of non-limiting example, the UE mobility and requests a CM update 1550 at corresponding VNFM(s) 120 (the other controller MFs 610 in the processing of FIG. 7) supporting the target UPF VNF(s) 200.

The VNFM(s) 120 supporting the UPF VNF(s) 200 update(s) 1580 the application configuration script 303 (the LCM/CM action 611 in the processing of FIG. 7) used by network address translation (NAT) functions at the corresponding target UPF VNF(s) 200 based on the generated CM update requests 1550.

Additionally, the A-CM 322 of the target EM 220 updates 1495 the VNFD(s)-A 324 (another DE 620 in the processing of FIG. 6) of the target EM 220.

### Method Actions

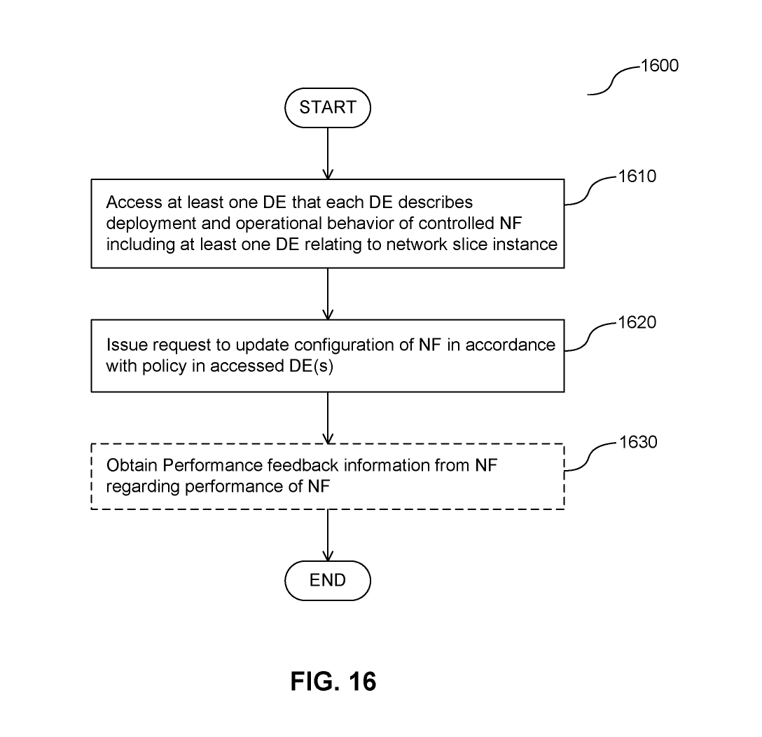

Turning now to FIG. 16, there is shown a flow chart, shown generally at 1600, showing example actions taken by the (controller) MF 610 in a method for managing the (controlled) NF 630 in a network slice instance.

One example action 1610 is to access 621 at least one DE 620 that each DE describes deployment and operational behaviour of the controlled NF 630 including at least one DE 620 relating to the network slice instance.

One example action 1620 is to issue 611 a request to update a configuration of the controlled NF 630 in accordance with policy in the accessed DE(s) 620.

One example action 1630 may be to obtain performance feedback information 631 from the NF entity 630 regarding performance of the NF entity.

### Example Device

Having described in detail example embodiments that are in accordance with the present disclosure, it is noted that the embodiments reside primarily in combinations of apparatus or devices and processing actions related to interactions between one or more of such components.

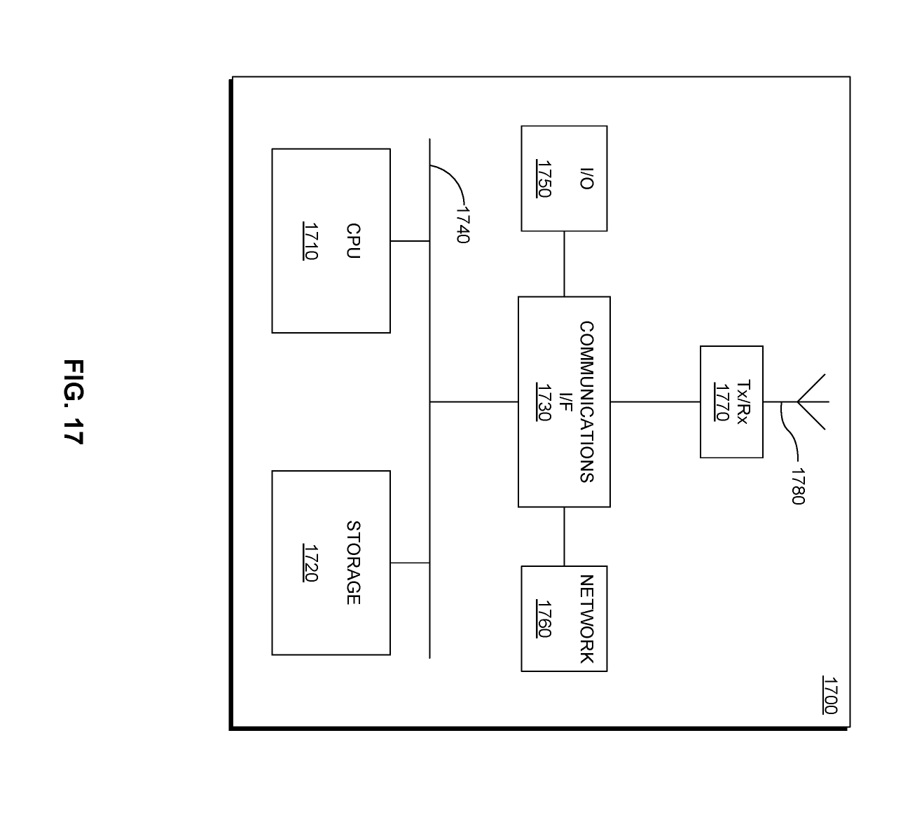

FIG. 17 is a block diagram of a processing system that may be used for implementing one or more devices, shown generally at 1700, such as the controlled MF 610 (which may be the EM 220, VNFM 120, NSM 340, EM/PNFM 520), and/or the VNF 200, PNF 500, NSO 350, MANO 100 and/or components thereof, for performing actions in one or more of the methods disclosed herein.

The device 1700 comprises a processing unit 1710, a storage medium 1720 and a communications interface 1730. In some example embodiments, the device 1700 may also comprise a processing bus 1740 interconnecting some or all of these components, as well as other devices and/or controllers. In some example embodiments, the device 1700 may comprise an input/output (I/O) device 1750, a network connectivity device 1760, a transceiver 1770 and/or an antenna 1780.

The processing unit 1710 controls the general operation of the device 1700, by way of non-limiting example, by sending data and/or control signals to the communications interface 1730, and by retrieving data and/or instructions from the storage medium 1720 to execute method actions disclosed herein.

However conFIG.d, the hardware of the processing unit 1710 is conFIG.d so as to be capable of operating with sufficient software, processing power, memory resources and network throughput capability to handle any workload placed upon it.

The storage medium 1720 provides storage of data used by the device 1700, as described above. The storage medium 1720 may also be conFIG.d to store computer codes and/or code sequences, instructions, configuration information, data and/or scripts in a computer program residing on or in a computer program product that, when executed by the processing unit 1710, causes the processing unit 1710 to perform one or more functions associated with the device 1700, as disclosed herein.

The communications interface 1730 facilitates communication with the I/O device(s) 1750, network connectivity device(s) 1760 and/or other entities in a communications network. In some example embodiments, the communications interface 1730 is for connection to a transceiver 1770, which may comprise one or more transmitters and/or receivers, and at least one antenna 1780, through which such communications are effected. As such, the communications interface 1730 may comprise one or more interfaces and a suitable number of ports, to couple internal and external I/O devices 1750, network connectivity devices 1760 and the like to the processing unit 1710.

Network connectivity devices 1760 may enable the processing unit 1710 to communicate with the internet or one or more intranets (not shown) to communicate with remote devices, for data processing and/or communications. The network connectivity devices 1760 may also comprise and/or interface with one or more transceivers 1770 for wirelessly or otherwise transmitting and receiving signals. With such a network connection, it is contemplated that the processing unit 1710 may receive information from the network or might output information to the network in the course of performing one or more of the above-described method actions.

The transceiver 1770 operates to prepare data to be transmitted and/or to convert received data for processing by the processing unit 1710.

Other components, as well as related functionality of the device 1700, may have been omitted in order not to obscure the concepts presented herein.

### Terminology

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances. In particular, the term “exemplary” should not be interpreted to denote or confer any laudatory, beneficial or other quality to the expression with which it is used, whether in terms of design, performance or otherwise.

The terms “couple” and “communicate” in any form are intended to mean either a direct connection or indirect connection through some interface, device, intermediate component or connection, whether electrically, mechanically, chemically, or otherwise.

Directional terms such as “upward”, “downward”, “left” and “right” are used to refer to directions in the drawings to which reference is made unless otherwise stated. Similarly, words such as “inward” and “outward” are used to refer to directions toward and away from, respectively, the geometric center of the device, area or volume or designated parts thereof. Moreover, all dimensions described herein are intended solely to be by way of example for purposes of illustrating certain embodiments and are not intended to limit the scope to any embodiments that may depart from such dimensions as may be specified.

References in the singular form include the plural and vice versa, unless otherwise noted.

As used herein, relational terms, such as “first” and “second”, and numbering devices such as “a”, “b” and the like, may be used solely to distinguish one entity or element from another entity or element, without necessarily requiring or implying any physical or logical relationship or order between such entities or elements.

### General

All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated that the present disclosure, which is described by the claims and not by the implementation details provided, which can be modified by omitting, adding or replacing elements with equivalent functional elements, provides many applicable inventive concepts that may be embodied in a wide variety of specific contexts. The specific embodiments discussed are merely illustrative of specific ways to make and use the disclosure, and do not limit the scope of the present disclosure. Rather, the general principles set forth herein are considered to be merely illustrative of the scope of the present disclosure.

It will be apparent that various modifications and variations covering alternatives, modifications and equivalents will be apparent to persons having ordinary skill in the relevant art upon reference to this description and may be made to the embodiments disclosed herein, without departing from the present disclosure, as defined by the appended claims.

Accordingly the specification and the embodiments disclosed therein are to be considered examples only, with a true scope of the disclosure being disclosed by the following numbered claims:

What is claimed is:

1. A method for managing a network function (NF) entity in a network slice instance at a management function (MF) entity in a management plane of the network slice instance, comprising:
accessing at least one descriptor entity (DE) in the management plane that each DE describes deployment and operational behaviour of the NF entity, including at least one DE that relates to the network slice instance; and
issuing a request to update a configuration of the NF entity in accordance with policy in the accessed DEs.

2. The method of claim 1, further comprising the action of obtaining performance feedback information from the NF entity regarding performance of the NF entity.

3. The method of claim 1, wherein the request comprises a request to scale resources allocated to the NF entity.

4. The method of claim 1, wherein the request comprises a request to manage a configuration of the NF entity.

5. The method of claim 1, wherein the action of accessing comprises monitoring application-level performance of the NF entity at an application performance manager (A-PM) component of the MF entity.

6. The method of claim 5, wherein the action of accessing comprises the A-PM component triggering a network manager (NM) entity for accessing at least one DE that relates to an associated network slice instance.

7. The method of claim 1, wherein the action of accessing comprises monitoring infrastructure-level performance of the NF entity at an infrastructure performance manager component of the MF entity.

8. The method of claim 7, wherein the infrastructure performance manager component forms part of a VNF manager (VNFM) in a management and orchestration (MANO) module.

9. The method of claim 8, wherein the action of accessing comprises the infrastructure performance manager component triggering a network manager (NM) entity for accessing at least one DE that relates to an associated network slice instance.

10. The method of claim 1, wherein the configuration is updated by updating a configuration script to conFIG. the NF entity in accordance with policy in the accessed DEs.

11. The method of claim 10, wherein the configuration script is an application configuration script to conFIG. an application-level (NF-A) entity.

12. The method of claim 11, further comprising the action of obtaining feedback information from the NF-A entity regarding application-level performance of the NF entity.

13. The method of claim 10, wherein the action of accessing is performed by an application configuration manager (A-CM) component and the A-CM component updates the configuration script.

14. The method of claim 10, wherein the configuration script is an infrastructure configuration script to conFIG. an infrastructure-level NF (NF-I) entity.

15. The method of claim 14, further comprising the action of obtaining feedback information from the NF-I entity regarding infrastructure-level performance of the NF entity.

16. The method of claim 10, wherein the action of accessing is performed by an infrastructure configuration manager component and the infrastructure configuration manager component updates the configuration script.

17. The method of claim 16, wherein the infrastructure configuration manager component forms part of a VNF manager (VNFM) component in a management and orchestration (MANO) module.

18. The method of claim 1, wherein the NF entity is selected from a group consisting of a virtual NF (VNF) entity and a non-virtualized physical NF (PNF) entity.

19. A node in a management function (MF) entity in a management plane of a network slice instance having a processor and a memory containing an MF software module that, causes the MF entity to manage a network function (NF) entity in the network slice instance, by:
accessing at least one descriptor entity (DE) in the management plane that each DE describes deployment and operational behaviour of the NF entity, including at least one DE that relates to the network slice instance; and
issuing a request to update a configuration of the NF entity in accordance with policy in the accessed DEs.

20. The node of claim 19, wherein the MF software module further causes the MF entity to obtain performance feedback information from the NF entity regarding performance of the NF entity.
